(19) United States
(12) Patent Application Publication
(10) Pub. No.: US 2007/0038435 A1
(43) Pub. Date: Feb. 15, 2007

(54) Emulation method, emulator, computer-attachable device, and emulator program

(76) Inventor: Takayoshi Koizumi, Abaraki (JP)

Correspondence Address: PAUL, HASTINGS, JANOFSKY & WALKER LLP, P.O. BOX 919092, SAN DIEGO, CA, 92191-9092, US

(21) Appl. No.: 11/498,046

(22) Filed: Aug. 3, 2006

(30) Foreign Application Priority Data
Aug. 10, 2005 (JP) 2005-231528
Aug. 10, 2005 (JP) 2005-231529

(51) Int. Cl. G06F 9/455

(52) U.S. Cl. 703/27

(57) ABSTRACT

Provided is a technique of optimizing a virtual operation timing of a processor after emulation. In order to accurately estimate the number of bus access cycles after the emulation, the number of cycles required for an access when an instruction is issued from a processor (MIPS) is divided for each of factors, and the number of bus access cycles is estimated as the sum of the numbers of cycles required for the respective factors. For example, a BusArbiter object receives data indicating a substantial time required for execution of a request from a peripheral that executes the request from the MIPS and a current status of a DMA from a DMA controller, and informs the MIPS of the received data and the received status. The MIPS optimizes its own virtual operation timing in accordance with the substantial time.

### CROSS REFERENCE TO RELATED APPLICATIONS

The present application claims priority from Japanese Application Nos. 2005-231528 filed Aug. 10, 2005 and 2005-231529 filed Aug. 10, 2005, the disclosures of which are hereby incorporated by reference herein.

### BACKGROUND. OF THE INVENTION

1. Field of the Invention

The present invention relates to an emulator, in particular, a technique of accurately adjusting operation timings of a plurality of hardware resources included in a given computer system upon implementing another computer system, which is different in performance etc., into the computer system.

2. Description of the Related Art

In order to operate a program created for a given computer system (first computer system) on another computer system (second computer system) having different processing performance and the like, an emulator is used. When the emulator is used to emulate a computer system on which a general program runs, the operation timings of some programs must strictly coincide with those of hardware resources. In order to emulate such a computer system, it is necessary to synchronize the operation timings of hardware resources with those of the programs in some way. In such a case, conventionally, the emulator estimates the virtual number of operation cycles of each of the hardware resources and compares the virtual number of operation cycles and the number of operation cycles of each of the hardware resources to adjust the operation timings of the programs after the emulation.

However, the program may not correctly run at a correct timing on the second computer system unless the virtual number of operation cycles of each of the hardware resource is estimated with sufficiently high accuracy.

For various reasons, however, it is difficult to estimate the virtual number of operation cycles of the hardware resource with high accuracy.

For example, when a system to be emulated includes a CPU and a peripheral connected to the CPU via a bus, it is necessary not only to operate the CPU and the peripheral at their respective correct timings but also to adjust the operation timings of the CPU and the peripheral to adjust the timings of the CPU and the peripherals in the entire system.

In order to adjust the timings totally as the entire system, it is apparent that the virtual number of operation cycles of each of the CPU and the peripheral is required to be estimated with high accuracy. However, it is particularly difficult to estimate the virtual number of operation cycles of the CPU among all the hardware resources. This is because the number of operation cycles of the CPU is likely to be affected by various factors such as the execution order of instructions, a cache, and a bus access.

For example, the number of operation cycles differs depending on whether or not a cache is present in the CPU, and even if the cache is present in the CPU, the number still differs depending on whether a hit or miss hit in the cache occurs. When a cache hit occurs, the operation is closed within the CPU to complete data exchange. However, when a cache miss hit occurs, it is necessary to calculate the number of operation cycles to elapse until the bus access right is acquired.

Furthermore, if the CPU to be emulated performs a pipeline operation, it will be further difficult to estimate the virtual number of operation cycles. Hereinafter, a description will be given for this regard.

The simplest emulator among the conventional ones serially processes instructions one by one. To be specific, an instruction is not executed unless the execution of the preceding instruction is completed. However, the recent processor, for example, a reduced instruction set computer (RISC) CPU, processes instructions in a pipeline. In the pipeline processing, the number of operation cycles in each stage is not fixed but depends on the adjacent (previous and subsequent) statuses. A general instruction is never completed in one cycle unless at least a cache hit occurs.

Therefore, there is a problem in that it is extremely difficult to adjust the operation timing of the program after emulation when a computer thus emulated includes a processor operating in a pipeline.

In view of the above problems, it is a primary object of the present invention to provide an emulation method of facilitating an adjustment of an operation timing of a program after emulation, for example, an emulation method of facilitating the adjustment of an operation timing of the entire system including a CPU and a peripheral.

Another object of the present invention is to provide an emulation method of enabling the synchronization of an operation timing of a program after emulation with an operation timing of a hardware resource.

Further another object of the present invention is to provide an emulation method of facilitating the adjustment of an operation timing of a program after emulating a computer having a processor for processing instructions in a pipeline.

A still further object of the present invention is to provide an emulator capable of carrying out the emulation method in a suitable manner, a computer-attachable device, and an emulator program for implementing the emulator on the computer.

### SUMMARY OF THE INVENTION

An emulation method according to one aspect of the present invention is to correctly estimate the number of bus access cycles after emulation to optimize an operation timing of a processor. For this propose, the number of cycles required for a bus access upon issuance of an instruction from a processor (MIPS) is divided for each of factors. The number of bus access cycles is estimated as the sum of the numbers of cycles for the respective factors.

More specifically, the emulation method includes the steps of: providing functions of a first computer by software in a second computer, said functions including a function of a processor, a function of a bus for connecting the processor and a peripheral, and a function of an arbitration means for arbitrating an access right of the bus; issuing, by a processor provided by the software, a predetermined request to the peripheral connected to the bus; transmitting, by the arbitration means, the request issued to the bus to the peripheral, receiving data indicating a substantial time required for performing the request from the peripheral, and transmitting the received data to the processor; and controlling, by the processor having received the data, its own virtual operation timing in accordance with the substantial time indicated by the data.

The “peripheral” is, for example, a peripheral device of a computer. The term “substantial time” denotes substantial time information. As an example, the substantial time is the number of bus access cycles for determining the virtual operation timing of the first computer. An operation clock is a kind of the substantial time as well.

The arbitration means arbitrates restriction means for restricting a part of the access of the processor to the bus, for example, a DMA functional block competing with the processor for the access right to the bus. The arbitration means may also add a substantial time required for the arbitration to a substantial time indicated by the data received from the peripheral to transmit data of the number of bus access cycles obtained by the addition to the processor. The arbitration means may also provide a cache memory and cache management means of the first computer, by software, in the second computer, in which the cache management means may judge a hit or a miss hit in the cache memory and may also determine a substantial time to be further added to the substantial time obtained by the addition in accordance with a result of the judgment. In this manner, a more practical substantial time can be obtained to thereby obtain the estimation of optimal virtual operation cycles in the processor after the emulation.

The present invention provides an emulator for implementing, by software, functions of a plurality of hardware resources included in a first computer which is different from a computer that includes the emulator is provided. The emulator includes: a processor object provided to correspond to a processor of the first computer; a peripheral object provided to correspond to a peripheral of the first computer; a bus object provided to correspond to a bus to which the processor and the peripheral are connected; and arbitration means for arbitrating an access to the bus object, and in the emulator, each of the peripheral object and the arbitration means has a function of returning a substantial time required for implementing an instruction requested thereto to a request source of the instruction, and the processor object has a function of issuing the request to the peripheral object connected to the bus object allowed to be accessed by the arbitration of the arbitration means and of controlling its own virtual operation timing in accordance with a substantial time required for receiving the result of the request.

The emulator according the present invention may further include a DMA controller object provided to correspond to a DMA controller in the first computer, the DMA controller competing with the processor for an access right to a bus, and in the emulator, the arbitration means may perform arbitration with the DMA controller object and add a substantial time required for the arbitration to the substantial time to be returned by itself.

The emulator according the present invention may further include a cache memory of the first computer and cache management means provided to correspond to cache management means in the first computer, the cache management means in the first computer having a function of returning a substantial time required for performing an instruction requested thereto to the processor object, and in the emulator, the cache management means may further judge which of a cache hit and a cache miss has occurred in the cache memory and determines a substantial time to be added to the substantial time to be returned to the processor object in accordance with a result of the judgment.

Further, according to the present invention, the processor object, the peripheral object, the bus object, the arbitration means and the like which are implemented by the above-described emulator can be provided by an attachable device or an emulator program.

According to another aspect of the present invention, a method of emulating a function of a processor for implementing an instruction in a pipeline is provided. The method includes the steps of: configuring the pipeline with a plurality of stages of processing blocks, in which adjacent blocks are associated with each other, and causing a processor object corresponding to the processor to operate the processing blocks in parallel and in an independent manner; inputting, by the processor object, the instruction to the plurality of stages of processing blocks; storing, by the operating processing block of the plurality of stages of processing blocks, the number of operation cycles incremented in each operation, for each step of the instruction; and outputting a maximum value of the stored numbers of operation cycles as the number of execution step cycles of the pipeline in the step.

The emulation method may further include the step of providing a register that can be accessed by the plurality of stages of processing blocks, and in the emulator, any of the processing blocks stores its own number of operation cycles in the register, and the processing block which has the number of operation cycles greater than that already stored updates the number of operation cycles stored in the register to its own number of operation cycles.

The present invention also provides an emulator for emulating an operation of a processor for implementing an instruction in a pipeline. The emulator includes: a processor object corresponding to the processor; a plurality of stages of processing blocks, in which adjacent processing blocks are associated with each other to correspond to the pipeline, the plurality of stages of processing blocks being operational in parallel and in an independent manner in accordance with control of the processor object; and cycle number storing means for storing the number of operation cycles of the processing block which has the greatest number of operation cycles among the plurality of stage of processing blocks, for each step of the input instruction, and in the emulator, the processor object outputs the number of operation cycles stored in the cycle number storing means as the number of execution step cycles of the pipeline in the step.

In an emulator according further another aspect of the present invention, the processor object sets the number of operation cycles stored in the cycle number storing means in the first step of the instruction to an initial value, judges, for each operation of the processing block in each stage, whether or not the number of operation cycles of the operated processing block is larger than the number of operation cycles already stored in the cycle number storing means, and enables the number of operation cycles stored in the cycle number storing means to be updated when the number of operation cycles of the operated processing block is larger. The plurality of stages of processing blocks may include a processing block having a fixed number of operation cycles regardless of the instruction.

Furthermore, according to the present invention, the processor object, the processing block, the cycle number retention means, and the like as implemented by the above-described emulator can be provided by an attachment device or an emulator program.

According to the present invention, the effect of facilitating the adjustment of the operation timing of the program after emulation can be obtained.

Further, according to the present invention, a bus connection configuration including a processor of a given computer (a first computer) is emulated to obtain a substantial time required for an instruction issued from the processor of the first computer to be returned to the processor. Therefore, even for the processor whose operation timing is varied by various factors, the virtual operation timing (number of virtual operation cycles) of the processor in the computer corresponding to the emulation destination (the second computer) can be easily synchronized with the operation timing (the number of operation cycles) of a hardware resource of the emulation destination.

Furthermore, according to the present invention, a pipeline is constituted by a plurality of stages of processing blocks, and each of the processing blocks can be configured such that processor objects corresponding to the processors operate in parallel and independently. In addition, for each step of an input instruction, the maximum value of the numbers of operation cycles of the operating processing block among the plurality of stages of the processing blocks is specified so as to be output as the number of execution step cycles of the pipeline in the step. Therefore, even for the processor executing an instruction in a pipeline in which the adjacent processings are related to each other, the number of operation cycles can be estimated in the emulation destination. Accordingly, the present invention has an excellent effect in that the synchronization of the numbers of operation cycles in the emulation destination is facilitated.

### BRIEF DESCRIPTION OF THE DRAWINGS

In the accompanying drawings:

FIG. 1 illustrates a configuration view of a target system to be emulated;

FIG. 2 illustrates an object diagram of an emulator according to the present invention;

FIG. 3 illustrates a sequence diagram of an instruction bus read access;

FIG. 4 illustrates a sequence diagram of a data bus read access;

FIG. 5 illustrates a sequence diagram of a data bus write access;

FIG. 6 illustrates a view showing a necessity of adjustment of operations in a pipeline;

FIG. 7 illustrates a view showing an exemplary internal configuration of a MIPS object (class);

FIG. 8 illustrates a view showing the relation between ExecData objects and phases being shifted;

FIG. 9 illustrates a view showing an exemplary instruction in emulating the pipeline;

FIGS. 10A and 10B illustrate each an explanatory view of the content such as a value of a step cycle number register, a value to be stored in a MIPS register block, and data to be stored in the ExecData object when the emulation is actually implemented;

FIGS. 11A and 11B illustrate an explanatory view of the content such as the value of the step cycle number register, the value to be stored in the MIPS register block, and the data to be stored in the ExecData object when the emulation is actually implemented;

FIGS. 12A and 12B illustrate an explanatory view of the content such as the value of the step cycle number register, the value to be stored in the MIPS register block, and the data to be stored in the ExecData object when the emulation is actually implemented;

FIGS. 13A and 13B illustrate an explanatory view of the content such as the value of the step cycle number register, the value to be stored in the MIPS register block, and the data to be stored in the ExecData object when the emulation is actually implemented;

FIGS. 14A and 14B illustrate an explanatory view of the content such as the value of the step cycle number register, the value to be stored in the MIPS register block, and the data to be stored in the ExecData object when the emulation is actually implemented;

FIGS. 15A and 15B illustrate an explanatory view of the content such as the value of the step cycle number register, the value to be stored in the MIPS register block, and the data to be stored in the ExecData object when the emulation is actually implemented;

FIGS. 16A and 16B illustrate an explanatory view of the content such as the value of the step cycle number register, the value to be stored in the MIPS register block, and the data to be stored in the ExecData object when the emulation is actually implemented;

FIGS. 17A and 17B illustrate an explanatory view of the content such as the value of the step cycle number register, the value to be stored in the MIPS register block, and the data to be stored in the ExecData object when the emulation is actually implemented;

FIGS. 18A and 18B illustrate an explanatory view of the content such as the value of the step cycle number register, the value to be stored in the MIPS register block, and the data to be stored in the ExecData object when the emulation is actually implemented;

FIG. 19 illustrates an explanatory view of the content such as the value of the step cycle number register, the value to be stored in the MIPS register block, and the data to be stored in the ExecData object when the emulation is actually implemented;

FIG. 20A illustrates a view showing the number of operation cycles in the first step when the instruction in FIG. 9 is operated in a pipeline;

FIG. 20B illustrates a view showing the number of operation cycles in the second step;

FIG. 20C illustrates a view showing the number of operation cycles in the third step; and

FIG. 20D illustrates a view showing the number of operation cycles in the last step.

### DESCRIPTION OF THE PREFERRED EMBODIMENT

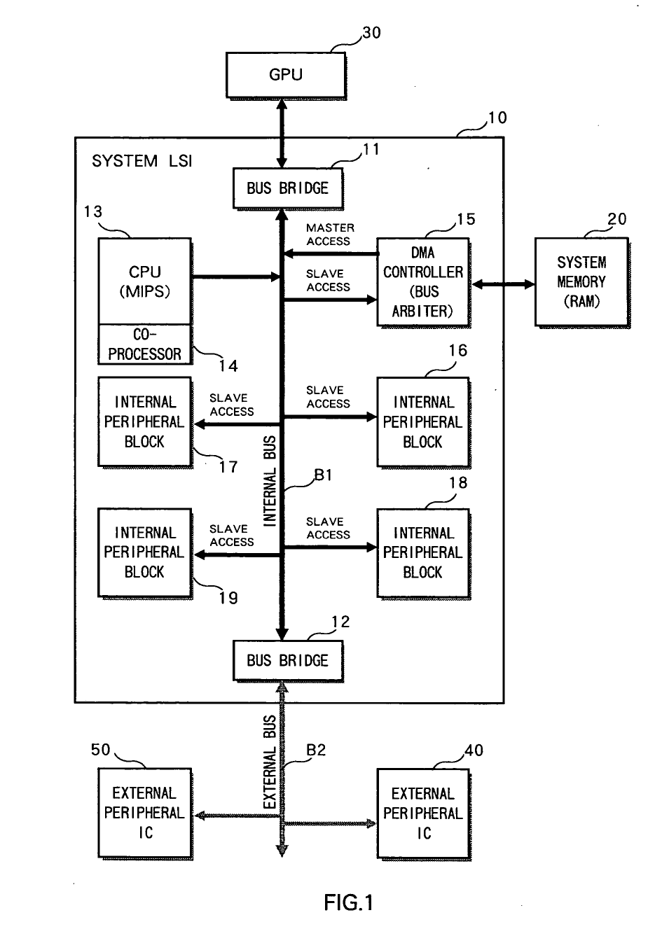

Hereinafter, a preferred embodiment of the present invention will be described. First, a computer system to be emulated (hereinafter, referred to as a “target system”) will be described. As in FIG. 1 showing an exemplary configuration, the target system is configured to include: a system LSI 10, specifically, a super-multifunction large scale integration (LSI), in which multiple functions are integrated on one chip; and a system memory 20 composed of a random access memory (RAM).

A graphics processing unit (GPU) 30 is connected to the system LSI 10 through a bus bridge 11. External peripheral ICs 40 and 50 and the like are also connected to the system LSI 10 through a bus bridge 12 and an external bus B2. An internal bus B1 is connected between the two bus bridges 11 and 12. A CPU 13, a direct memory access (DMA) controller 15, and a plurality of internal peripheral blocks 16 to 19 are connected to the internal bus B1.

In this example, the CPU 13 is a MIPS core (a CPU core designed by MIPS technologies, Inc.). Being the MIPS core, the CPU 13 includes a co-processor 14 for vector operations. The co-processor 14 is an RISC processor which simplifies an instruction set to enable a high-speed processing. The DMA controller 15 allows a DMA from the CPU 13 and has the function of bus arbiter (arbitration). The system memory 20 is connected to the DMA controller 15. Each of the internal peripheral blocks 16 to 19 cooperates with the CPU 13 to execute a specific hardware function.

Each of the CPU 13 and the DMA controller 15 operates as a bus master. Therefore, the CPU 13 and the DMA controller 15 compete with each other for the access right to the internal bus B1. When the external peripheral ICs 40 and 50 are connected to the internal bus B1 through the external bus B2 and the bus bridge 12, a register group for each of the external peripheral ICs 40 and 50 is mapped on a memory map of the system memory 20.

When the CPU 13 accesses a block such as the system memory 20 through the internal bus B1, the CPU 13 first has to acquire the bus access right by bus arbitration. An access by the CPU 13 to acquire the bus access right is referred to as a “master access”. For the master access, while the internal bus B1 is being used by the DMA controller 15, the access from the CPU 13 is made to wait. When the CPU 13 acquires the access right, a block to be accessed is notified of the access. An access after the acquisition of the access right by the CPU 13 is referred to as a “slave access”. For the slave access, depending on a status of the block to be accessed, the number of access cycles differs. Moreover, when the block to be accessed is on the external bus B2, a latency of the bus bridge 12 is required.

As described above, the operation timing of the CPU 13, for example, the number of bus access cycles, is determined by three elements, that is, the number of cycles until the acquisition of the access right to the internal bus B1, the number of cycles for making a bus access, and the number of response cycles of the block to be accessed.

[Exemplary Configuration of Emulator]

Next, an exemplary configuration of an emulator for emulating the target system, according to the present invention will be described.

The emulator according to the present invention is implemented by the cooperation of an emulator program and a computer or computer system including a memory. To be specific, a processor of a computer or the like to implement the emulation (hereinafter, referred to as a “second computer”) reads and executes the emulator program, or an attachment device is attached to the second computer. As a result, the second computer operates as the emulator. The emulator according to the present invention can also be implemented by connecting the attachment device to an internal bus or an external bus of the second computer or inserting the attachment device into a predetermined slot in connection with the processor of the second computer.

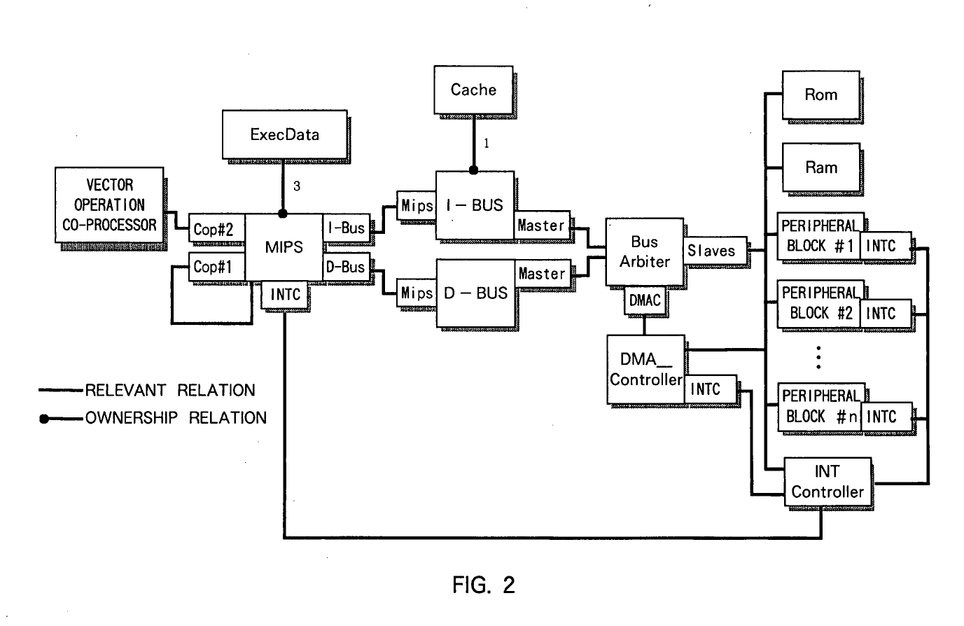

The emulator can represent hardware resources including the CPU 13 and the bus connection configuration of the target system shown in FIG. 1 and their operations as an assembly of objects, each having its proper role. FIG. 2 is an object diagram of the emulator. In FIG. 2, a line represents a relevant relation, and a line with a point of origin represents an ownership relation attributing to the point of origin.

Referring to the object diagram of FIG. 2, a MIPS object provided (or formed) to correspond to the CPU 13 includes a Cop1, a Cop2, an I-BUS, a D-BUS, and an INTC as connection terminals for relevant connections with the other objects.

The Cop1 is provided as a system co-processor of the MIPS. Since the system co-processor is closely associated with the MIPS core, the MIPS object itself is in charge of its function. Therefore, the MIPS object itself is connected to the Cop1 as shown in FIG. 2. In the target system, a vector operation unit is connected to the co-processor. A connection terminal for emulating the vector operation unit is the other co-processor (Cop2). A vector operation co-processor object corresponding to the co-processor 14 shown in FIG. 1 is connected to the Cop2.

As is well known, the MIPS employs a Harvard architecture. Therefore, two buses, i.e., an instruction bus (I-BUS) and a data bus (D-BUS) are present as the external bus B2 in the target system. In order to emulate the two buses, as shown in FIG. 2, an I-BUS connection terminal and a D-BUS connection terminal are present for the MIPS object. The I-BUS connection terminal is connected to an I-BUS object, whereas the D-BUS connection terminal is connected to a D-BUS object.

An INTC connection terminal of the MIPS object is used for an interface with an external interrupt controller to emulate an external interrupt, and is connected to an INT Controller object.

The I-BUS object emulates a memory management unit (MMU) of the instruction bus (I-BUS). The I-BUS object performs address conversion (physical address/logical address conversion) from the instruction bus and determines a hit/miss hit in an instruction cache (a Cache object shown in FIG. 2). In order to emulate the function as a BusMaster, a Master connection terminal is present for the I-BUS object. A BusArbiter object is connected to the Master connection terminal.

The D-BUS object emulates an MMU of the data bus (D-BUS), performs address conversion (physical address/logical address conversion) from the data bus, and manages a WriteBuffer of four phases. In order to emulate the function as a BusMaster, a Master connection terminal is present for the D-BUS object. The BusArbiter object is connected to the Master connection terminal.

The BusArbiter object estimates the number of bus access cycles counted until the bus access right is acquired in accordance with a status of a DMA_Controller, upon issuance of a bus access request from the I-BUS object or the D-BUS object. For this purpose, the BusArbiter object has a DMAC connection terminal to connect to the DMA_Controller object.

The BusArbiter object has a Slaves connection terminal connect to a plurality of Peripheral objects. The Slaves connection terminal is for one-to-many connection. The BusArbiter object manages each of the Peripheral objects by, for example, mapping on the memory map. For example, when a bus access is made from the I-BUS object or the D-BUS object, the appropriate Peripheral object is found in accordance with the memory map to make a bus access.

Among the Peripheral objects, the DMA_Controller object and the INT Controller object take on special functions in the emulator according to the present invention.

The DMA_Controller object emulates the DMA controller in the target system and monitors the status of the DMA being activated at the present point of time. Therefore, in order to estimate the number of cycles of the bus arbitration, the BusArbiter object makes a request of acquiring the status of the DMA.

The INT Controller object manages the interrupt. More specifically, in response to an interrupt request from each of the peripheral blocks, the INT Controller object manages an interrupt flag to the MIPS object. Therefore, each of the Peripheral #1 to #n objects deriving from a Peripheral class in FIG. 2 has an INTC connection terminal for an interrupt request. Each INTC connection terminal is connected to the INT Controller object. The INC Controller object is also connected to the INTC connection terminal of the MIPS object. At the timing of accepting the interrupt, the MIPS object requests the INT Controller object to acquire a status of the interrupt flag.

[Estimation of the Virtual Number of Operation Cycles]

Next, in the emulator configured as described above, a method of estimating the number of bus access cycles after the emulation will be described. The number of bus access cycles is the number of operation cycles from the request for a bus access by the BusMaster to the completion of the bus access. In this example, the operations in the case where three types of access, specifically, an instruction bus read access, a data bus read access, and a data bus write access, occur and a method of estimating a bus latency will be described.

<Instruction Bus Read Access>

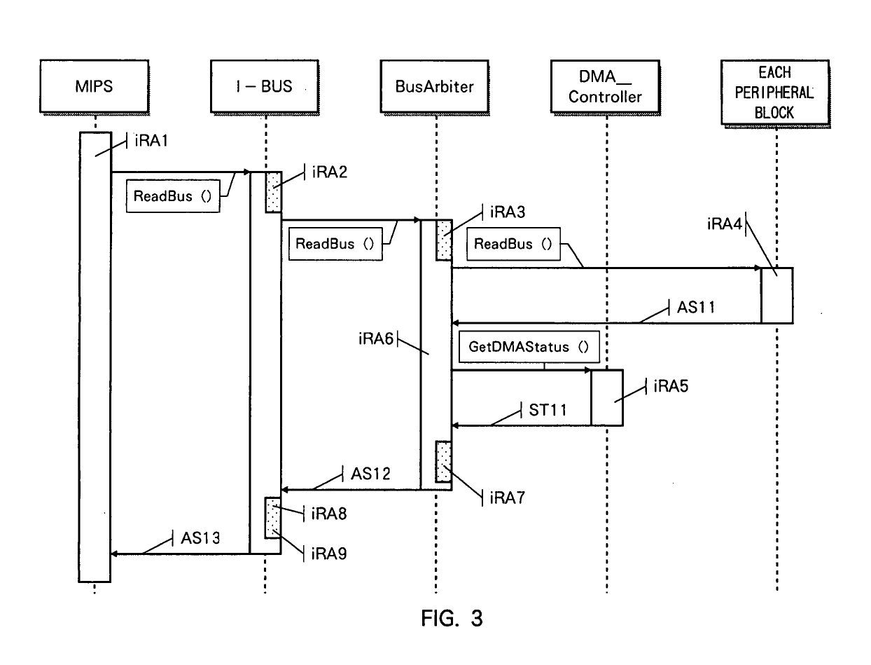

FIG. 3 is a sequence diagram of an instruction bus read access. The upper row shows object names. Referring to FIG. 3, the MIPS object issues an instruction read access to the I-BUS object (iRA1). At this time, a request command transmitted to the I-BUS object is “ReadBus( )”. After performing a predetermined address conversion, the I-BUS object transmits an instruction request, for example, a data request to the BusArbiter object (iRA2). At this time, a request command transmitted to the BusArbiter object is “ReadBus( )”.

The BusArbiter object makes a request for data to the peripheral blocks (objects) corresponding to targets of address map matching (iRA3). At this time, a request command transmitted to each of the peripheral blocks #1 to #n is “ReadBus( )”. The corresponding peripheral block returns read data stored at a requested address and data of the number of access cycles required for reading (AS11) to the BusArbiter object corresponding to a request source (iRA4).

The BusArbiter object also makes a request to the DMA_Controller object for data indicating a status of the DMA (iRA5). At this time, a request command transmitted to the DMA_Controller object is “GetDMAStatus( )”. The DMA_Controller object returns a DMA status indicating the status of the DMA (ST11) to the BusArbiter object (iRA5). As a result, the BusArbiter object can receive the current status of the DMA (iRA6). Therefore, the BusArbiter object determines the number of cycles of arbitration based on the status of the DMA. The BusArbiter object adds the determined number of cycles of arbitration to the number of access cycles required for reading and transmits the read data and the data of the number of access cycles after the addition (AS12) to the I-BUS object (iRA7).

The I-BUS object judges the occurrence of a cache hit/miss hit to start the calculation of the number of access cycles to be returned to the MIPS object (iRA8). At this time, when the occurrence of a miss cache is judged, the number of cycles obtained with the read data is determined as the number of access cycles to be returned to the MIPS object. When the occurrence of a cache hit is judged, one cycle is determined as the number of access cycles to be returned to the MIPS object. Then, the I-BUS object transmits the read data and data of the determined number of access cycles (AS13) to the MIPS object (iRA9).

As a result, since the MIPS object obtains the precise number of bus access cycles reflecting the current status of the DMA and the status of the cache, the MIPS object can adjust the number of its own virtual operation cycles to the obtained number of bus access cycles.

<Data Bus Read Access>

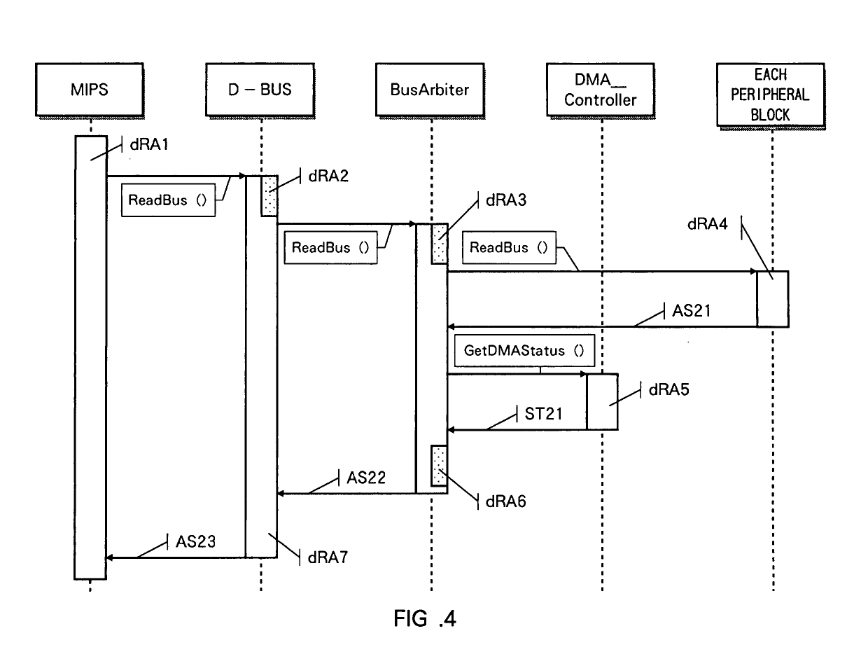

FIG. 4 is a sequence diagram of a data bus read access. The upper row shows object names. Referring to FIG. 4, the MIPS object issues data read access to the D-BUS object (dRA1). At this time, a request command transmitted to the D-BUS object is “ReadBus( )”. After performing a predetermined address conversion, the D-BUS object transmits a data read request to the BusArbiter object (dRA2). At this time, a request command transmitted to the BusArbiter object is “ReadBus( )”.

The BusArbiter object makes a request for data to the peripheral blocks (objects) corresponding to targets of address map matching (dRA3). At this time, a request command transmitted to each of the peripheral blocks #1 to #n is “ReadBus( )”. The corresponding peripheral block returns read data stored at a requested address and data of the number of access cycles required for reading (AS21) to the BusArbiter object corresponding to a request source (dRA4). The BusArbiter object also makes a request to the DMA_Controller object for data indicating a status of the DMA (dRA5). At this time, a request command transmitted to the DMA_Controller object is “GetDMAStatus( )”. The DMA_Controller object returns a DMA status indicating the status of the DMA (ST21) to the BusArbiter object (dRA5). The BusArbiter object determines the number of cycles of arbitration based on the status of the DMA. The BusArbiter object adds the determined number of cycles of arbitration to the number of access cycles required for reading to transmit the read data and the data of the number of access cycles after the addition (AS22) to the D-BUS object (dRA6).

The D-BUS object transmits the read data and data of the number of access cycles after the addition (AS22) to the MIPS object (dRA7) without any processing (AS23). As a result, the MIPS object can figure out the precise number of bus access cycles reflecting the current status of the DMA and the status of the cache.

Even in the case of the data bus read access, the number of access cycles may be added in consideration of the cache management function as in the case of the instruction bus read access.

<Data Bus Write Access>

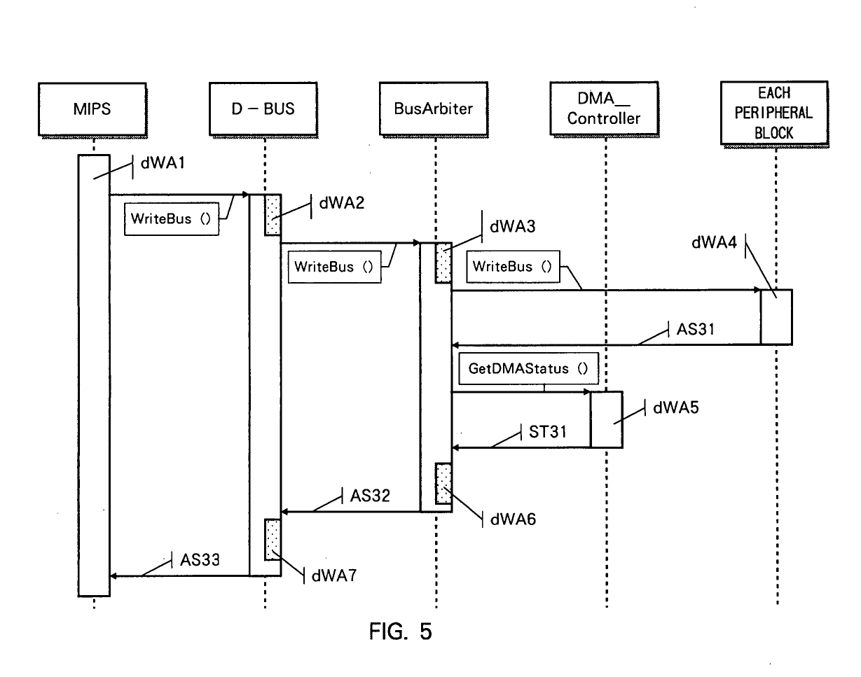

FIG. 5 is a sequence diagram of a data bus write access. The upper row shows object names. Referring to FIG. 5, the MIPS object issues a data write access to the D-BUS object (dWA1). At this time, a request command transmitted to the D-BUS object is “WriteBus( )”. After performing a predetermined address conversion, the D-BUS object transmits a data write request to the BusArbiter object (dWA2). At this time, a request command transmitted to the BusArbiter object is “WriteBus( )”.

The BusArbiter object makes a request for data writing to the peripheral blocks (objects) corresponding to targets of address map matching (dWA3). At this time, a request command transmitted to each of the peripheral blocks #1 to #n is “WriteBus( )”. The corresponding peripheral block returns completion of data write at a requested address and data of the number of access cycles required for access (AS31) to the BusArbiter object corresponding to a request source (dWA4). The BusArbiter object also makes a request to the DMA_Controller object for data indicating a status of the DMA (dWA5). At this time, a request command transmitted to the DMA_Controller object is “GetDMAStatus( )”. The DMA_Controller object returns a DMA status indicating the status of the DMA (ST31) to the BusArbiter object (dWA5). The BusArbiter object determines the number of cycles of arbitration based on the status of the DMA. The BusArbiter object adds the determined number of cycles of arbitration to the number of access cycles required for writing and transmits the data of the number of access cycles after the addition (AS32) to the D-BUS object (dWA6).

When a WriteBuffer has free space, the D-BUS object determines the number of cycles as 1 and transmits it to the MIPS object. Otherwise, the D-BUS object transmits the returned data of the number of cycles (AS33) to the MIPS object (dWA7). As a result, the MIPS object can estimate the precise number of access cycles reflecting the current status of the DMA and the status of the WriteBuffer.

As described above, in order to implement the functions of the plurality of hardware resources included in the target system, the emulator according to this embodiment includes the MIPS object provided to correspond to the CPU 13 of the target system, the peripheral object provided to correspond to the peripheral of the target system, the I-BUS object and the D-BUS object provided to correspond to the internal bus B1 and the external bus B2, and the DMA_Controller object provided to correspond to the DMA controller 15. The emulator further includes the BusArbiter object having the bus access arbitration function and the object for performing the cache management. Accordingly, in the computer after the emulation, the virtual number of operation cycles for operating the program running on the target system can be accurately estimated. Therefore, the virtual operation timing of the MIPS after the emulation can be easily controlled.

Moreover, the blocks are divided for each of the factors of the number of cycles required for the bus access. The number of bus access cycles is estimated as the sum of the numbers of cycles required for the respective blocks. Therefore, the effect of increasing an estimation accuracy is obtained.

[Estimation of Operation Timing in View of Pipeline]

In the RISC processor such as the MIPS, a pipeline is used in addition to the above-described Harvard architecture, to increase the parallelization of operations and to reduce the apparent number of instruction execution cycles. The pipeline divides an instruction operation into the appropriate number of phases and operates the phases in parallel to increase the speed of the operation of the instruction. For emulating the operation of the MIPS core, the operation of the pipeline is also considered to enable the estimation of the number of operation cycles of the execution of an instruction with higher accuracy and the external output of the estimated number of operation cycles.

In this embodiment, an exemplary operation in the case where a pipeline of the MIPS object is emulated to make each of the accesses to the I-BUS and the D-BUS independent to more accurately estimate the number of instruction operation clocks will be described.

General operation phases of the pipeline include five phases; an F-(fetch) phase, a D-(Decode) phase, an E-(Execute) phase, an M-(MemoryAccess) phase, and a W-(WriteBack) phase. When each of the F-phase and the M-phase of the above five phases is configured as an independent bus, the above-described Harvard architecture is obtained.

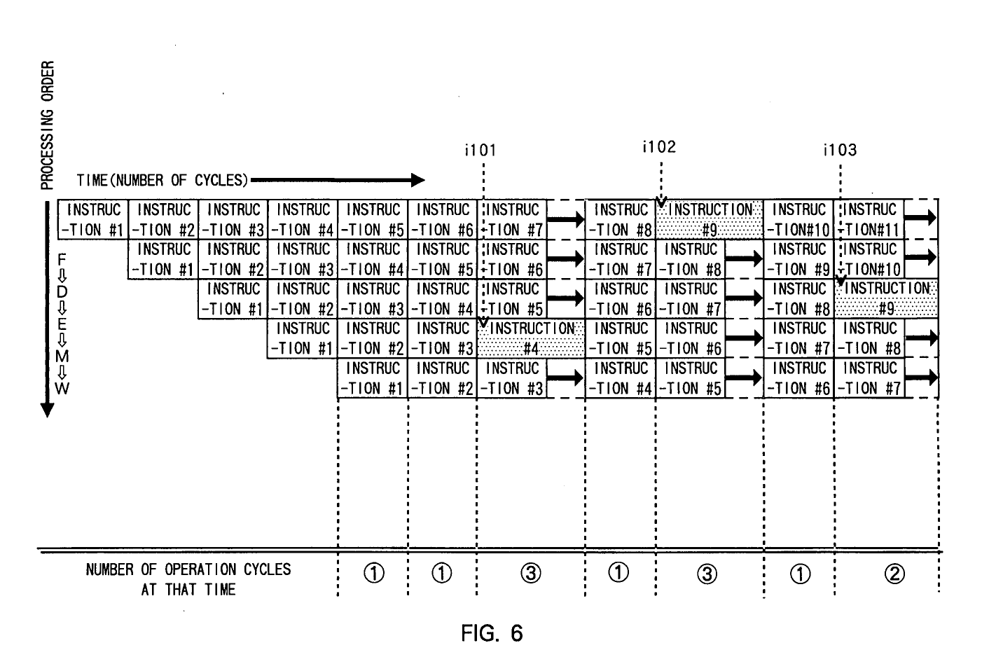

Although these phases operate in parallel, the adjacent phases are associated with each other. Therefore, the phases cannot operate independently but are required to be adjusted to each other. To be specific, the maximum number of cycles required in the respective phases corresponds to the number of cycles required for the operation. This state is shown in FIG. 6.

In FIG. 6, the abscissa axis indicates a time (t), whereas the ordinate indicates the order of processings. The order of processings is the F-phase, the D-phase, the E-phase, the M-phase, and the W-phase. All the phases operate in parallel and sequentially issue instructions for execution. Numerical values in the lowermost row correspond to the numbers of operation cycles at the corresponding time. In FIG. 6, reference symbol i101 indicates a state where all the phases are made to wait for the completion of a memory access when the memory access is made in response to an instruction #4 and the number of access cycles is not 1.

Moreover, in FIG. 6, reference symbol i102 indicates a state where all the phases are made to wait for the completion of a fetch because of a delay of the instruction fetch in response to an instruction #9. Similarly, reference symbol i103 indicates a state where the other phases are made to wait for the completion of execution of an instruction #9 because the execution of the instruction #9 requires two cycles.

Among the five phases, each of the D-phase and the W-phase requires only a fixed time of one cycle. Therefore, it is three factors, specifically, the number of cycles required for the F-phase (I-bus access latency), the number of cycles required for the E-phase (several cycles are infrequently required although one cycle is required for a normal instruction), and the number of cycles required for the M-phase that determine the number of execution cycles of the MIPS object corresponding to the CPU 13 shown in FIG. 1.

To be specific, the numbers of cycles for these three factors in the pipeline are independently estimated. The maximum number of cycles among the estimated numbers of cycles is used as the number of execution step cycles to enable the estimation of the number of operation cycles with higher accuracy.

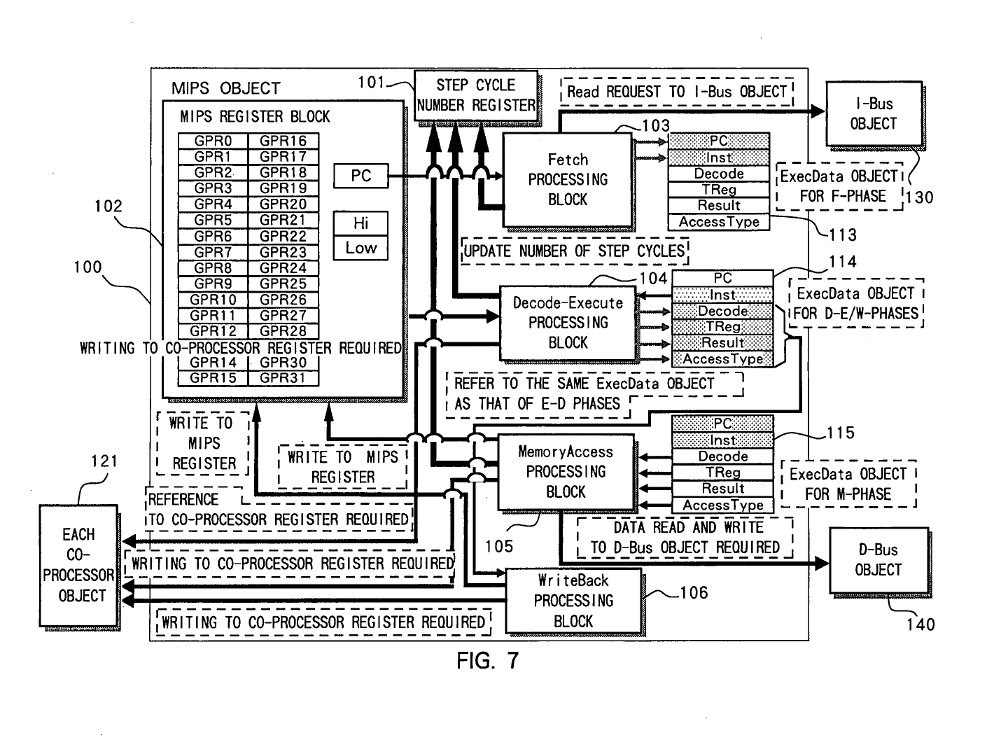

For the description of the operation of the pipeline, the above-described MIPS object will be described in detail. FIG. 7 is a diagram showing an exemplary internal configuration of the MIPS object.

A MIPS object 100 includes a step cycle number register 101, a MIPS register block 102, a Fetch processing block 103, a Decode-Execute processing block 104, a MemoryAccess processing block 105, a WriteBack processing block 106, and three ExecData objects 113 to 115 for temporarily storing the results of processings of the respective processing blocks 103 to 106 during the operation. The operations of the above-described blocks 101 to 106 are controlled by a control mechanism (not shown) of the MIPS object 100.

The step cycle number register 101 is a register (variable) which is set to 0 at the start of execution of a step and allows the processing block in each of the phases to store the maximum value in response to an update request of the number of processing cycles required for its own phase.

The MIPS register block 102 emulates a hardware register of the MIPS. The MIPS register block 102 has “PC”, “Hi”, and “Low” for the MIPS object and thirty-two “general-propose registers (GPRs)”. The “PC” is a value of a program counter, and “Hi” and “Low” are unique values.

In each of the three ExecData objects 113, 114, and 115, members such as “PC”, “Inst”, “Decode”, “TReg”, “Result”, and “AccessType” are present.

The “PC” is an address when the “Inst” is read. The “Inst” is instruction code. The “Decode” is the result of analysis of the instruction. The “Decode” is used to determine whether the instruction is Load or Store, a block of a target register (the MIPS register or the co-processor register), whether the instruction is a branching instruction or not, and the like. The “TReg” stores data to be written in the case of a Store instruction. Otherwise, a target register number is stored in the “TReg”. The “Result” stores an access target address in the case of the Load/Store instruction. Otherwise, operation result data is stored in the “Result”. The “AccessType” stores, in the case of the Load/Store instruction, an access data length or a co-processor number to be accessed. In the case of a co-processor instruction, a co-processor number to be accessed is stored in the “AccessType”. Otherwise, the “AccessType” is not in use.

The Fetch processing block 103 refers to the “PC” in the MIPS register block 102 and obtains data of an address indicated by the “PC” by using the I-BUS object. The Fetch processing block 103 stores the read data with a value of the “PC” in the “PC” and the “Inst” of the ExecData object 113. At this time, the number of data reading cycles obtained from the I-BUS object is used to update the step cycle number register 101.

The Decode-Execute processing block 104 refers to the instruction stored in the “Inst” of the ExecData object 114 to judge the type of instruction stored therein. The Decode-Execute processing block 104 refers to the MIPS register block 102, the co-processor register of each co-processor object 121 as needed to update the values of the “Decode”, the “TReg”, the “Result”, and the “AccessType” of the ExecData Object 114. At this time, the number of cycles required for the execution is estimated to update the step cycle number register 101.

The MemoryAccess processing block 105 first refers to the “Decode” of the ExecData object 115 to judge whether or not the instruction is a memory access instruction. When the instruction is riot a memory access instruction, the processing is terminated without any further processing. When the instruction is a memory access instruction, it is judged whether the “Decode” indicates Load or Store. Moreover, the MemoryAccess processing block 105 refers to the access target address stored in the “Result” to issue a Read/Write access request to the D-BUS object. In the case of Store, data to be written is stored in the “TReg”. In the case of Load, the “AccessType” and the “TReg” are referred to identify a storage destination block and a register number to store written data in a designated register. At this time, the number of data reading cycles obtained from the D-BUS object is used to update the step cycle number register 101.

The WriteBack processing block 106 is provided for implementing a delay slot of the MIPS. The WriteBack processing block 106 shares the ExecData object 114 with the Decode-Execute processing block 104. The WriteBack processing block 106 updates the result of execution other than that of the memory access instruction in the register after the execution of the MemoryAccess processing block 105 to emulate the delay slot of the MIPS.

The WriteBack processing block 106 first increments the “PC” in the MIPS register block 102. Next, the WriteBack processing block 106 refers to the “Decode” in the ExecData object 114 to judge whether or not the instruction is a memory access instruction. When the instruction is a memory access instruction, the processing is terminated without any further processing. When the instruction is not a memory access instruction, the WriteBack processing block 106 refers to the “AccessType” and the “TReg” to judge which register in which block is to be updated. Then, the Writeback processing block 106 updates a value of the “Result” in the target register. Since this processing is always completed in one cycle in the MIPS, the step cycle number register 101 is not particularly required to be updated.

A processing performed by the Fetch processing block 103 is an F-processing, a processing performed by the Decode-Execute processing block 104 is a D-E processing, a processing performed by the MemoryAccess processing block 105 is an M-processing, and a processing performed by a WriteBack processing block 106 is a W-processing. By executing the processings in the order of the F-processing, the D-E processing, the M-processing, and the W-processing with the use of the emulator according to this embodiment, the number of cycles ultimately required for the step can be obtained from the data in the step cycle number register 101.

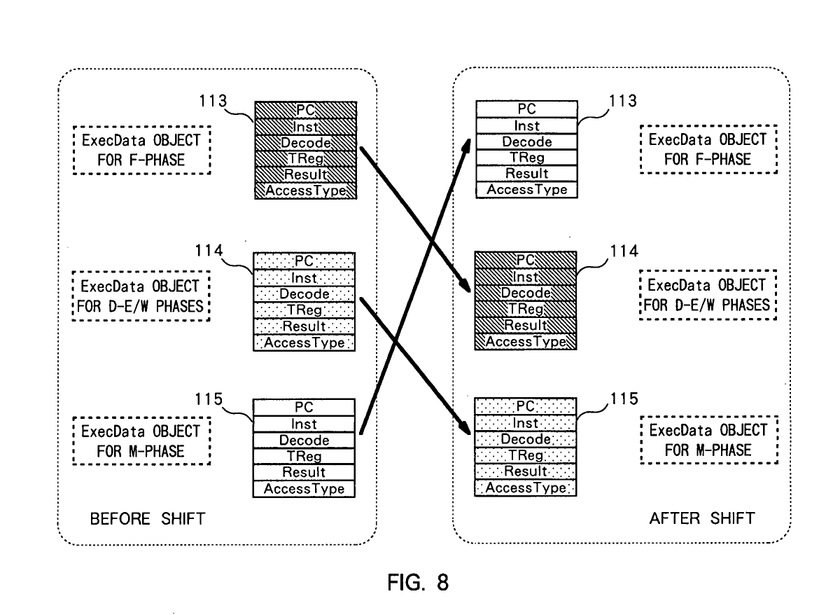

Moreover, after the completion of the execution of one step, the relation between the ExecData objects and the respective phases is shifted as shown in FIG. 8. As a result, the instructions are sequentially executed. FIG. 8 shows the ExecData objects before the shift on the left and those after the shift on the right.

In the MIPS object shown in FIG. 7, the processing in the D-phase and the processing in the E-phase are unified as the D-E processing, and an ExecData object for the W-processing is not provided. This is for the following reasons.

=First Reason=

In the First reason, the number of stages in the pipeline is taken into consideration. If the number of stages in the pipeline is incremented, the processing speed becomes slower. For example, forwarding for avoiding a data hazard or the like has to be taken into consideration. Therefore, it is advantageous to perform the processing with the number of stages as small as possible. The MIPS employs one-stage delayed branch and one-stage load delay. In the delayed branch, an instruction executed subsequent to a branching instruction is not an instruction at the branch target but an instruction following the branching instruction even when the branch is taken (the branching is established). In the MIPS, one subsequent instruction is executed (one stage). When a load instruction is executed, a loaded value is not used for an instruction subsequent to the load instruction. Therefore, it is necessary to perform a processing of using the loaded value at an appropriate timing. The load delay means the implementation of this processing not by means of hardware but by means of software. The advantage in introducing the two stages is that hardware implementation is simplified to enable an increase in operating frequency.

=Second Reason=

In the Second reason, the data hazard and the forwarding are taken into consideration.

For example, it is assumed that the following two instructions are issued.

$1=$2+$3 (instruction 1)

$4=$1+$1 (instruction 2)

When $1=0, $2=1, and $3=2 are given as a first condition, $4 should result in 6. In the hardware, these instructions pass through the above-described five stages of the pipeline. However, it is in the W-phase that the instructions are written in a register file.

When the instruction 2 enters the D-phase to access the register file to read out the value of $1, the instruction 1 still remains in the E-phase and therefore not in the W-phase. Thus, $1 in the register file is still 0. If the processing is continued, $4 is 0. To be specific, in order to precisely perform the processing, the instruction 2 has to wait in the D-phase until the instruction 1 enters the W-phase. This phenomenon is a data hazard. A technique for avoiding the data hazard is forwarding.

In forwarding, an output from an operation unit in the E-phase, a latch to be input in the M-phase, and an input in the W-phase are looped back to a location where the result in the D-phase is passed to the E-phase. In this manner, the latest value of the register, which has not been written in the register file yet, can be used in the D-phase. By implementation of the forwarding, the instruction 2 in the D-phase can take the result of an instruction 3 in the E-phase (specifically, 3) as the value of the $1 register. Therefore, 6 is correctly stored in the $4 register without being brought into any wait status, that is, without stalling the pipeline.

When the pipeline is emulated by the emulator, the same problem arises if the D-phase, the E-phase, and the W-phase are separately executed, that is, the ExecData objects are separately executed. In this case, the need of processing to cope with this problem arises.

To be specific, in the emulator, it is desirable to execute the E-phase, the D-phase, and the W-phase as one processing. As a result, it is no longer necessary to take the data hazard into consideration.

=Third Reason=

In the third reason, the delayed branch is taken into consideration. In order to emulate the delayed branch, it suffices that the branch is executed in a phase subsequent to the F-phase. The execution of the delayed branch corresponds to writing an address of a branch target to the PC. Therefore, in the simple implementation, the delayed branch is executed in the W-phase. This is because the policy that the value of the register is rewritten only in the W-phase can be maintained in this manner.

As described for the second reason above, if the D-phase, the E-phase, and the W-phase are performed as one processing, the W-phase is executed in a cycle subsequent to the F-phase. Therefore, for the delayed branch, the interest common to that in the second reason is obtained.

=Fourth Reason=

In the Fourth reason, the load delay is taken into consideration. In the load delay, an access of the register to be loaded in response to an instruction subsequent to the load instruction is not guaranteed by hardware. To be specific, the access has to be guaranteed by software. If an instruction of referring to the register to be loaded is issued as an instruction subsequent to the load instruction, the value prior to the execution of the load instruction is read out. The emulation can be implemented by separately performing the D-phase and the E-phase, and the M-phase. This is in consideration of an overwrite instruction of a register to be loaded in an instruction subsequent to the load instruction.

In such a case, the order of instructions should be respected. For this purpose, the W-phase is required to be implemented after the execution of the M-phase.

=Generalization=

It is the estimation of the number of cycles that is desired to be executed in the MIPS object. As described above, the F-phase, the E-phase, and the M-phase are required for estimating the number of cycles. These phases are required to be independently operated. On the other hand, it is desirable that the D-phase and the W-phase operate simultaneously with the E-phase. Furthermore, the W-phase has to be executed after the M-phase. Therefore, the D-phase is executed simultaneously with the E-phase. Moreover, although the W-phase has to be executed after the execution of the M-phase, the W-phase is executed simultaneously with the E-phase as a virtual step. As a result, the D-phase and the E-phase are unified as one. The ExecData object for the W-phase is used for both the D-phase and the E-phase. For each of the above-described reasons, in this embodiment, the processings in the D-E phases are unified as one, and the ExecData object for the W-phase is also used for the D-E phases.

### SPECIFIC EXAMPLE

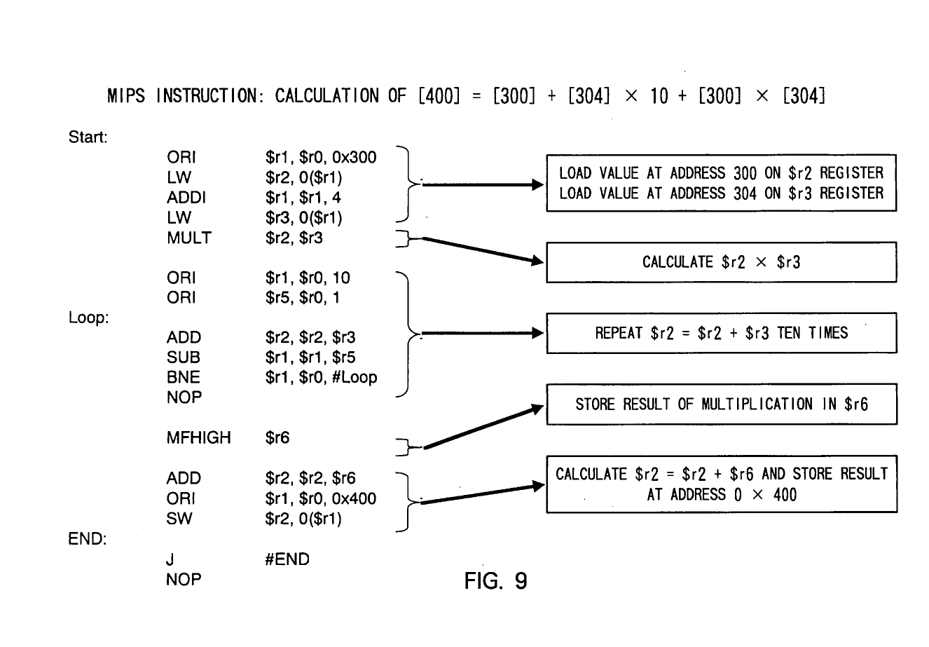

Next, in the emulator according to this embodiment, an example where the pipeline is emulated will be specifically described. For convenience, an example of a simple calculation as shown in FIG. 9 will be described by using a MIPS instruction in this example.

Among the phases in the pipeline, in the F-phase, an instruction is read from an address indicated by the “PC”. In the D-phase, the read instruction is interpreted to select original data that is needed in the next phase. The result of decoding in the D-phase is also used in the subsequent phase. In the E-phases, an operation is performed on the data selected in the D-phase. The type of operation or the like is selected based on the results of processings in the D-phase, which are sequentially transmitted. In the M-phase, a memory access is made in response to the results of operation. The type of access and information indicating whether or not to make an access are selected based on the results of processing in the D-phase, which are sequentially transmitted. When the memory access is not made, the result in the E-phase is transmitted to the next phase without any further processing. In the W-phase, the general register file is updated based on the ultimate result. The register file to be updated is selected based on the results of processings in the D-phase, which are sequentially transmitted. The register file is terminated without being updated for some results of processings in the D-phase. The “PC” is incremented by one and is continued to be updated unless a jump instruction is issued.

Among the above-described five phases, each of the D-phase and the M-phase is fixed to one cycle. Therefore, the remaining three phases, that is, the F-phase, the E-phase, and the M-phase, affect the number of step execution cycles.

Since it is apparent that the order of instructions has to be the same as that of the hardware, the pipeline is emulated in the following four steps.

Fetch→Decode & Execute→Memory→WriteBack and PC update

Under the above-described premises, the number of operation cycles when the MIPS instruction shown in FIG. 9 is operated by the emulator will be examined. The instructions are the following four.

ORI $r1, $r0, 0×300

LW $r2, 0($r1)

ADDI $r1, $r1, 4

LW $r3, 0($r1)

When the number of lines of the cache is “4”, there is an extremely high possibility that, of the four instructions described above, the three instructions other than the first one make a cache hit. In the MIPS, however, the value of $r0 is fixed to 0.

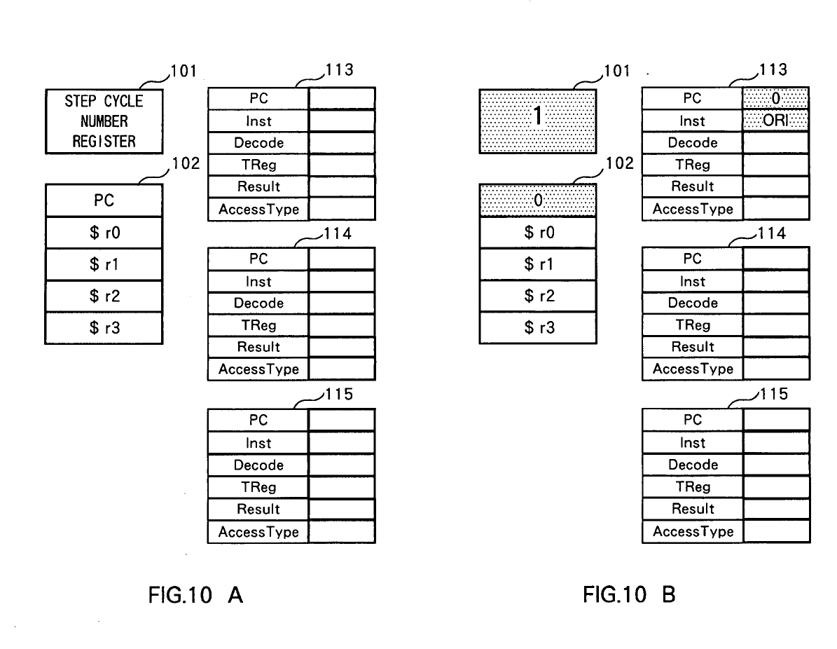

FIG. 10A shows an exemplary structure of the step cycle number register 101, the MIPS register block 102, the ExecData object for F-phase 113, the ExecData object for D-E/W phases 114, and the ExecData object for M-phase 115. Although a large number of register blocks are practically present in the MIPS register block 102 as shown on the upper left of FIG. 7, only necessary register blocks are shown. The number of step execution cycles is stored in the step cycle number register 101.

At the beginning of the execution of the step, the “PC” in the MIPS register block 102 is initialized to 0, whereas a step counter is initialized to “1”. The value of the step counter “1” is stored in the step cycle number register 101. In the F-phase, these PC values 0 and 1 are referred to, thereby obtaining an instruction code. Then, the obtained instruction code is stored in the ExecData object 113 associated with the F-phase (FIG. 10B).

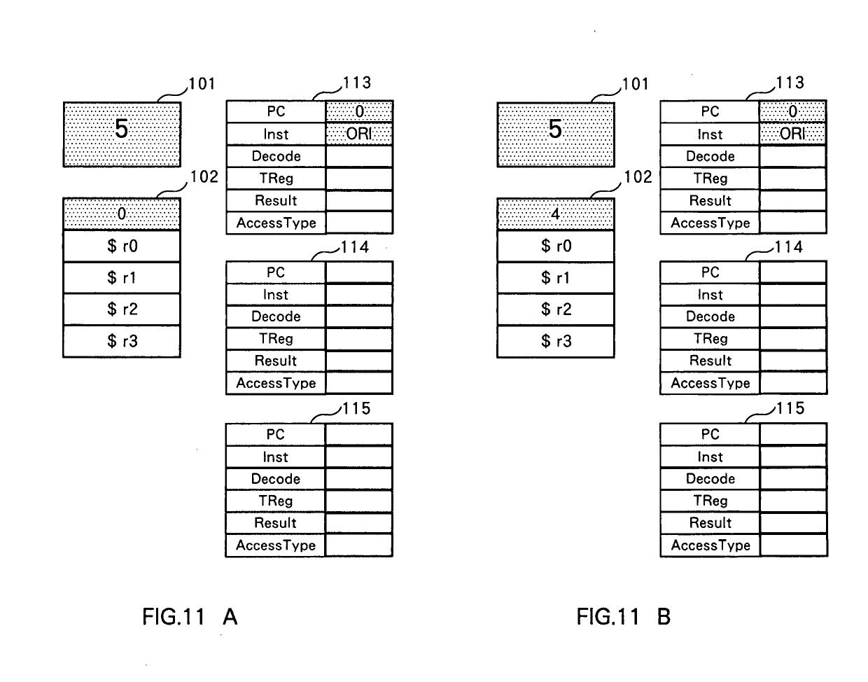

After that, the number of cycles required for the bus access is set as the number of step execution cycles (hereinafter, it is assumed that the number of step execution cycles is “5”). As a result, the number of step execution cycles is updated from “1” to “5” (FIG. 11A).

In the D-phase, the “Inst” of the ExecData object for the D-E/W phases 114 is read and decoded. Since the “Inst” is free at the present time, no processing is performed and the number of execution cycle is “1”. Since this number is smaller than the number of step execution cycles “5”, no update is performed.

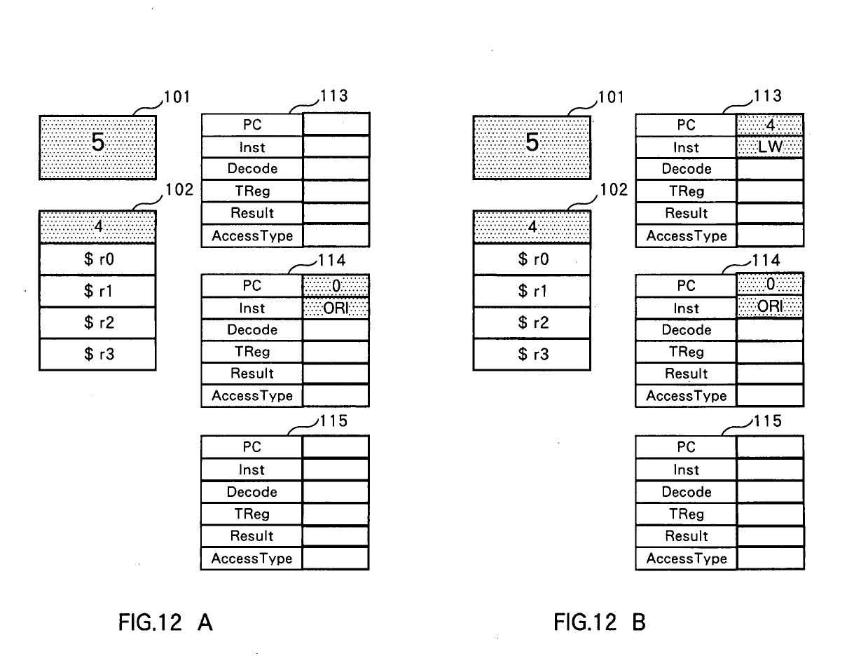

In the M-phase, the “Decode” of the ExecData object for M-phase 115 is read to confirm the execution/non-execution of the memory access. Since the “Decode” is free at the present time, no processing is performed and the number of execution cycle is “1”. Since this number is smaller than the number of step execution cycles “5”, no update is performed. In the W-phase, “4” is added to the “PC” in the MIPS register block 102 to update the result (FIG. 11B). In this processing, it is checked whether it is an instruction other than the memory access or not. Since the “Inst” is free at the present time, no processing is performed. In order to proceed to the next step, the relation of the ExecData objects 113 to 115 is shifted. To be specific, the content of the ExecData object for F-phase 113 is shifted to the ExecData object for D-E/W-phases 114 (FIG. 12A).

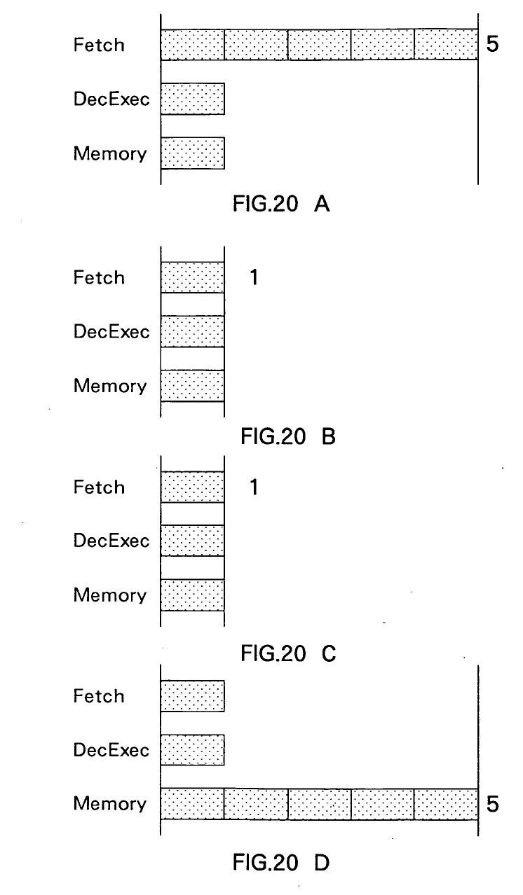

As a result of the above-described emulating operation, the number of execution cycles in each of the phases is affected by the processing in the F-phase as shown in FIG. 20A. The number of operations cycles is “5”, that is, the value stored in the step cycle number storing register 101.

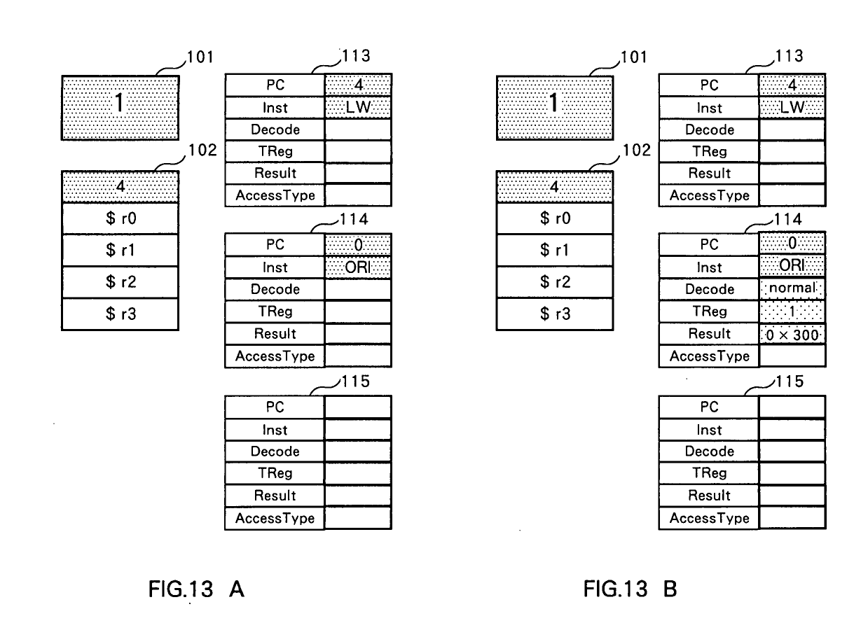

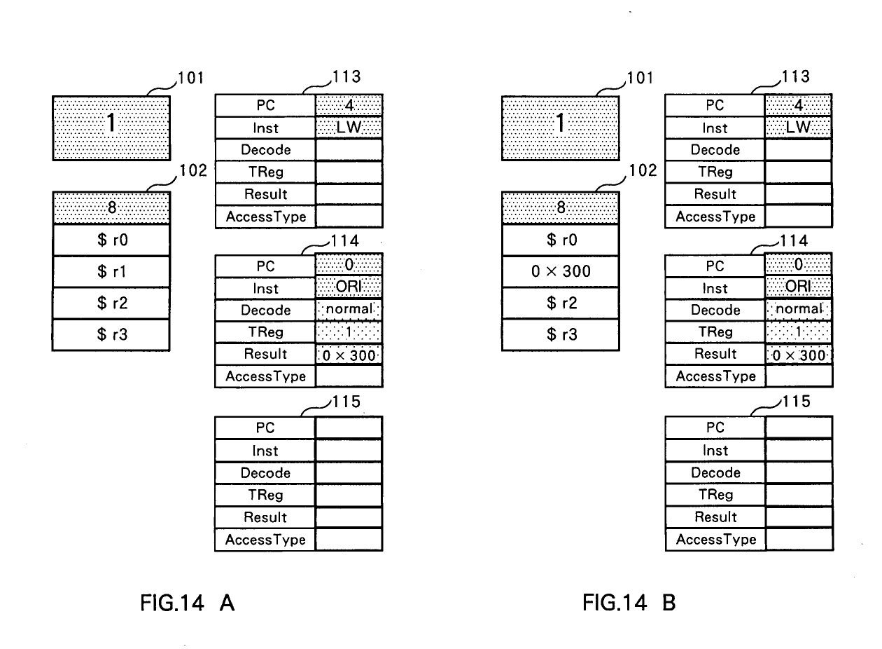

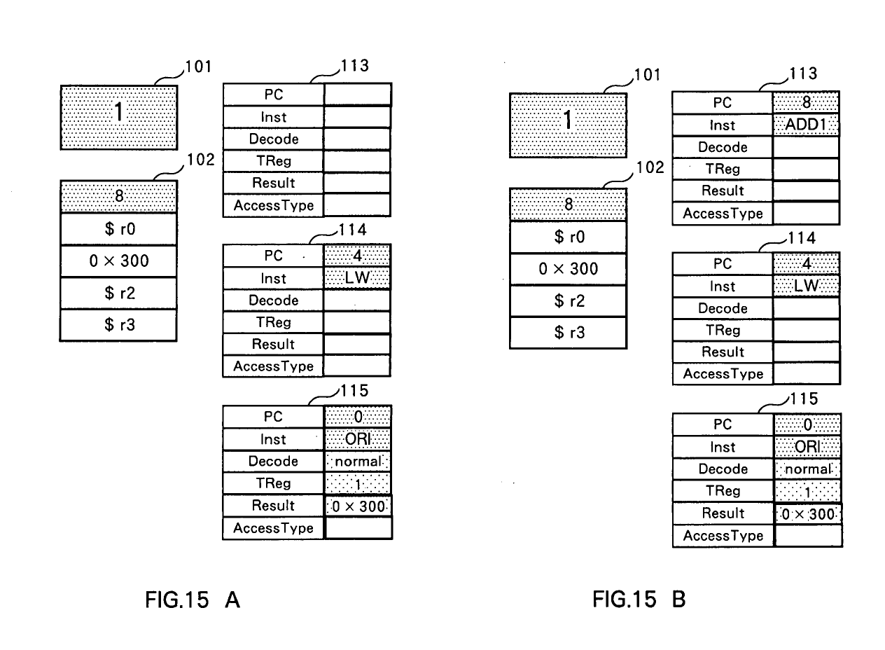

In the next step, first, in the F-phase, the PC value “5” is referred to, thereby obtaining an instruction code. Then, the obtained instruction code is stored in the ExecData object 113 (FIG. 12B). After that, the number of cycles required for the bus access is written in the step cycle number register 101 (“1” as a cache hit”; FIG. 13A). In the D-phase, the “Inst” in the ExecData object 114 is read to interpret “ORI $r1, $r0, 0×300”. Then, information indicating a normal instruction (normal) is stored in the “Decode”, “1” indicating a register to be updated is stored in the “TReg”, and $r0 (=0) and the result of the logical addition “0×300” are stored in the “Result” (FIG. 13B). The ORI instruction is set to “1” and is compared with the counter value “1” to terminate DecodeExe in one cycle. In the case of this example, the ORI instruction is not updated because it is equal to or smaller than the counter value. In the M-phase, since no processing is performed, no status change occurs. In the W-phase, the “PC” is first updated (FIG. 14A). Next, the “Decode” is read from the ExecData object 114 to confirm that the instruction is not a memory access. Since the “Decode” is “normal”, the register indicated by the value of the “TReg” is updated with the value of the “Result”. To be specific, “0×300” is set to the $r1 in the MIPS register block 102 (FIG. 15B). In order to proceed to a next step, the relation of the ExecData objects 113 to 115 is shifted (FIG. 15A).

As a result of the emulating operation described above, the number of execution cycles in each of the phases is “1” upon completion of the processing of all the phases as shown in FIG. 20B. Therefore, a value stored in the step cycle number register 101 in this case is “1”.

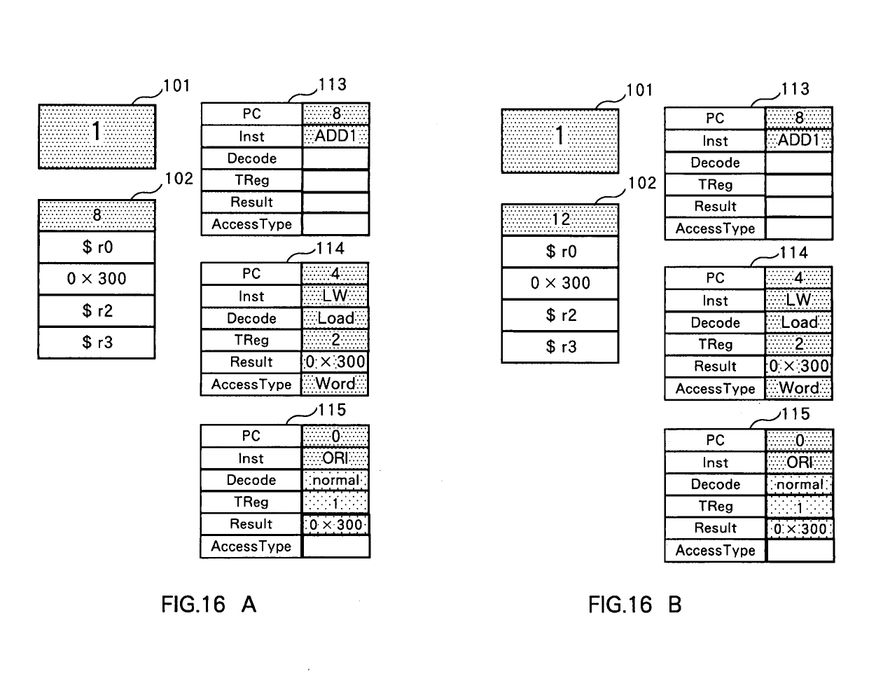

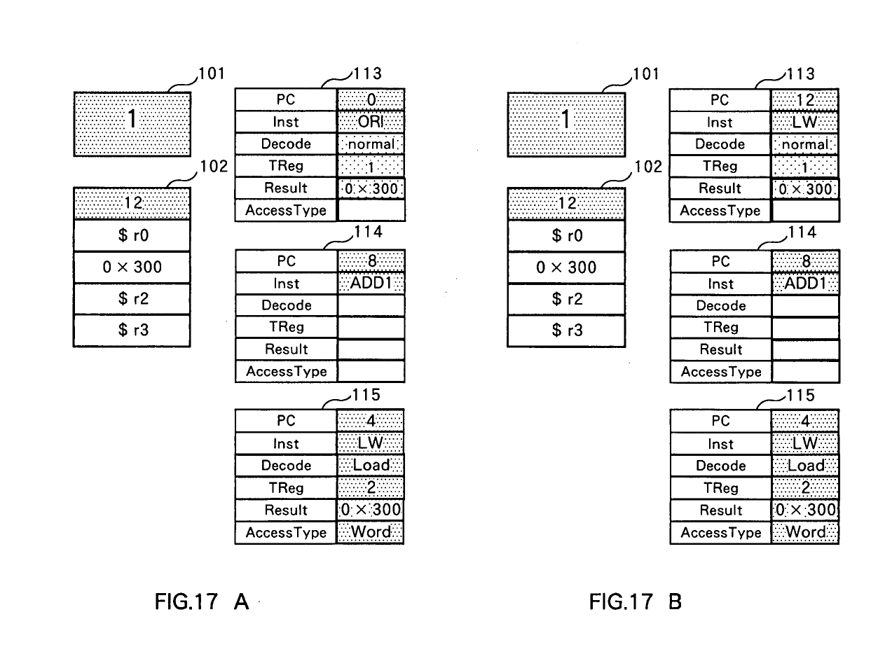

In the third step, first, in the F-phase, the PC value “8” is referred to, thereby obtaining an instruction code. Then, the obtained instruction code is stored in the ExecData object 113 (FIG. 15B). After that, the number of bus access cycles is written as “1” corresponding to the number of cache hits to rewrite the counter value. In the D-phase, the “Inst” is read from the ExecData object 114 to interpret “LW $2, 0 ($r1)”. Then, “Load” is stored in the “Decode”, “2” is stored in the “TReg”, “0×300” corresponding to 0+$r1 is stored in the “Result”, and “Word” is stored in the “AccessType” (FIG. 16A). Since the processing of the LW in the D-phase is completed in one cycle, “1” is compared with the counter value. Since the number of processing is equal to or smaller than the counter value, no update is performed. In the M-phase, the “Decode” in the ExecData object 115 is read. Since the “normal” is stored in the “Decode”, it is judged that no memory access is made. In the W-phase, after updating the “PC” to “12”, the “Decode” in the ExecData object 114 is read (FIG. 16B). Since the “Load” is stored in the “Decode”, the instruction is judged as being a memory access instruction. As the processing, no processing is performed. In order to proceed to a next step, the relation of the ExecData objects 113 to 115 is shifted (FIG. 17A).

As a result of the emulating operation described above, the number of execution cycles in each of the phases is “1” upon completion of the processing of all the phases as shown in FIG. 20C. Therefore, a value stored in the step cycle number register 101 in this case is “1”.

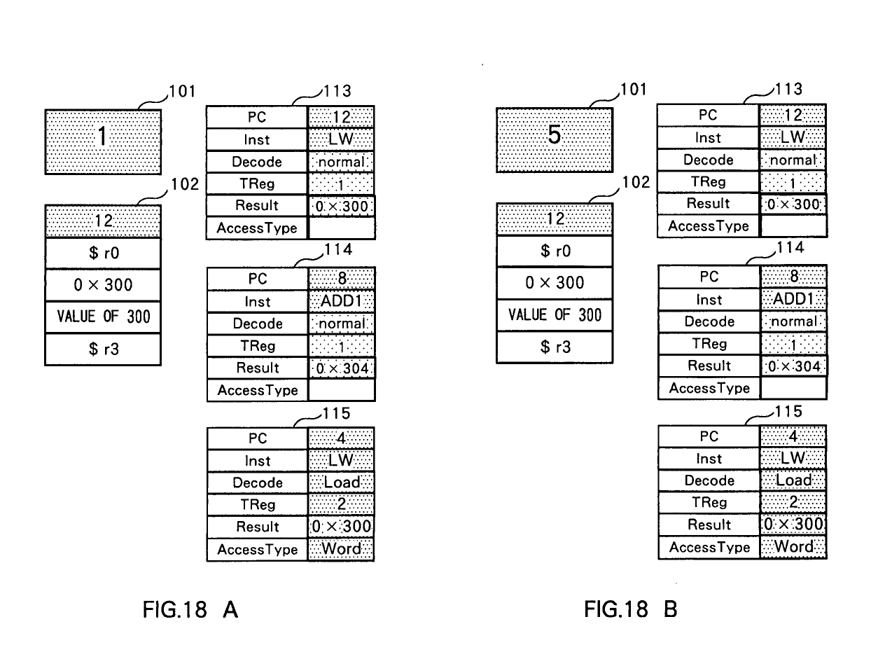

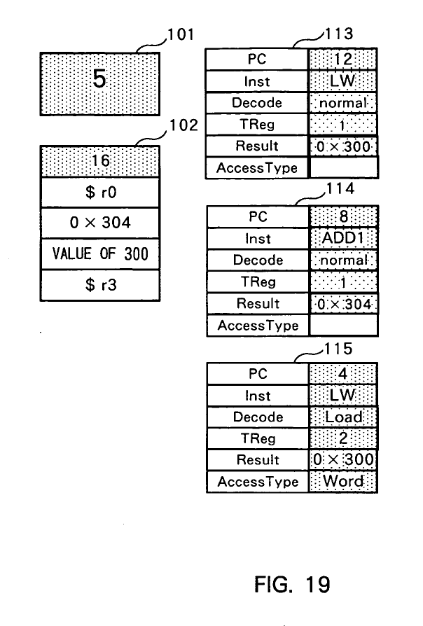

In the last step, first, in the F-phase, as in the above-described processings, the “PC” and the “Inst” are written. As the bus access, a cache hit is determined again. The number of cycles is determined as one, and the counter value is updated to “1” (FIG. 17B). In the D-phase, the “Inst” is read from the ExecData object 114 to compute “$1+4”. The result is stored in the “Result”. In the “TReg”, “1” is stored. In the “Decode”, “normal” is stored. The number of cycles is “1” (FIG. 18A). In the M-phase, the “Decode” in the ExecData object 115 is read to confirm the “Load”. Then, a bus access is made to the address indicated by the “Result” in the size indicated by the “AccessType” (Word=4 Byte). Then, the result is written to the register indicated by the “TReg”. It is assumed that five cycles are required for the bus access to the address 0×300. In this case, since the number of cycles is larger than the counter value, the counter value is updated to “5” (FIG. 18B). In the W-phase, after the “PC” is updated to “16”, the “Decode” in the ExecData object 114 is read. Since the “normal” is stored in the “Decode”, the value of the “Result” is written to the register indicated by the “TReg” (FIG. 19).

As a result of the above-described emulating operation, the number of execution cycles in each of the phases is affected by the processing in the M-phase as shown in FIG. 20D. Therefore, the number of operation cycles is “5”.

As described above, when the MIPS core is to be emulated, the pipeline included by the RISC processor is also emulated. As a result, it is possible to calculate the number of cycles with high accuracy. The emulation of the pipeline means the processings are divided for each of the pipeline phases to be sequentially executed without executing the instructions one by one. For the execution, the longest time of the times required for the phases is selected as the number of cycles required for the step. As a result, the synchronization with the number of operation cycles of the other hardware resources is ensured.

In the embodiment and the example described above, the emulator configured with an object-oriented tool has been described as an example. However, the present invention is not necessarily executed only by such a tool. For example, the present invention can be carried out as a software emulator. Besides, a part of the function of the emulator can be configured by software, whereas the remaining part can be configured by hardware.

The present invention can be widely used in apparatuses for operating a program for another computer having different performance or the like at a correct operation timing such as an entertainment apparatus and a communication apparatus.

What is claimed is:

1. An emulation method comprising steps of:
providing functions of a first computer by software in a second computer, said functions including a function of a processor, a function of a bus for connecting the processor and a peripheral, and a function of an arbitration means for arbitrating an access right of the bus;
issuing, by a processor provided by the software, a predetermined request to the peripheral connected to the bus;
transmitting, by the arbitration means, the request issued to the bus to the peripheral, receiving data indicating a substantial time required for performing the request from the peripheral, and further transmitting the received data to the processor; and
controlling, by the processor having received the data, its own virtual operation timing in accordance with the substantial time indicated by the data.

2. The emulation method according to claim 1, wherein the arbitration means arbitrates restriction means for restricting a part of accesses of the processor to the bus and adds a substantial time required for the arbitration to the substantial time indicated by the data received from the peripheral to transmit data of the number of bus access cycles obtained by the addition to the processor.

3. The emulation method according to claim 2, wherein the restriction means comprises a direct memory access (DMA) functional block competing with the processor for an access right to the bus.

4. The emulation method according to claim 2, further comprising the step of providing, by the software, a cache memory of the first processor and cache management means, wherein said cache management means judging which of a cache hit and a cache miss has occurred in the cache memory and determining a substantial time to be further added to the substantial time obtained by the addition in accordance with a result of the judgment.

5. The emulation method according to claim 4, wherein the substantial time is the number of bus access cycles for determining the virtual operation timing of the first computer.

6. The emulator for implementing, by software, functions of a plurality of hardware resources included in a first computer which is different from the emulator, comprising:
a processor object provided to correspond to a processor of the first computer;
a peripheral object provided to correspond to a peripheral of the first computer;
a bus object provided to correspond to a bus to which the processor and the peripheral are connected; and
arbitration means for arbitrating an access to the bus object, wherein:
each of the peripheral object and the arbitration means has a function of returning a substantial time required for implementing an instruction requested thereto to a request source of the instruction; and
the processor object has a function of issuing the request to the peripheral object connected to the bus object allowed to be accessed by the arbitration of the arbitration means and of controlling its own virtual operation timing in accordance with a substantial time required for receiving the result of the request.

7. The emulator according to claim 6, further comprising a DMA controller object provided to correspond to a DMA controller in the first computer, the DMA controller in the first computer competing with the processor for an access right to a bus,
wherein the arbitration means performs arbitration with the DMA controller object and adds a substantial time required for the arbitration to the substantial time to be returned by itself.

8. An emulator according to claim 7, further comprising a cache memory of the first computer and cache management means provided to correspond to cache management means in the first computer, the cache management means in the first computer having a function of returning a substantial time required for performing an instruction requested thereto to the processor object,
wherein the cache management means further judges which of a cache hit and a cache miss has occurred in the cache memory and determines a substantial time to be added to the substantial time to be returned to the processor object in accordance with a result of the judgment.

9. A computer-attachable device for implementing functions of a first computer in a second computer, said functions including a function of a processor, a function of a bus to which the processor and a peripheral are connected, and a function of an arbitration means for arbitrating an access right to the bus, wherein:
the computer-attachable device provides, upon being attached to the second computer, in the second computer through cooperation with hardware resources of the second computer:
a processor object provided to correspond to the processor of the first computer;
a peripheral object provided to correspond to the peripheral of the first computer;
a bus object provided to correspond to the bus to which the processor and the peripheral are connected; and
arbitration means for arbitrating an access to the bus object;
the computer-attachable device provides each of the peripheral object and the arbitration means with a function of returning a substantial time required for implementing an instruction requested thereto to a request source of the instruction; and
the computer-attachable device provides the processor object with a function of issuing the request to the peripheral object connected to the bus object that is allowed to be accessed by the arbitration of the arbitration means and of controlling a virtual operation timing in the second computer in accordance with a substantial time required for receiving a result of the request.

10. An emulator program for causing, by software, a second computer to operate as an emulator for implementing functions of a plurality of hardware resources included in a first computer different from the second computer, the emulator program causing the second computer to function as:
a processor object provided to correspond to a processor of the first computer;
a peripheral object provided to correspond to a peripheral of the first computer;
a bus object provided to correspond to a bus to which the processor and the peripheral are connected; and
arbitration means for arbitrating an access to the bus object, wherein:
the emulator program provides each of the peripheral object and the arbitration means with a function of returning a substantial time required for implementing an instruction requested thereto to a request source of the instruction; and
the emulator program provides the processor object with a function of issuing the request to the peripheral object connected to the bus object allowed to be accessed by the arbitration of the arbitration means and of controlling its own virtual operation timing in accordance with a substantial time required for receiving a result of the request.

11. A method of emulating a function of a processor for implementing an instruction in a pipeline, the method comprising steps of:
configuring the pipeline with a plurality of stages of processing blocks, in which adjacent blocks are associated with each other, and causing a processor object corresponding to the processor to operate the processing blocks in parallel and in an independent manner;
inputting, by the processor object, the instruction to the plurality of stages of processing blocks;
storing, by the operating processing block of the plurality of stages of processing blocks, the number of operation cycles incremented in each operation, for each step of the instruction; and
outputting a maximum value of the stored numbers of operation cycles as the number of execution step cycles of the pipeline in the step.

12. The emulation method according to claim 11, further comprising the step of providing a register that can be accessed by the plurality of stages of processing blocks, wherein:
one of the processing blocks stores the number of operation cycles of said one of the processing blocks in the register; and
the processing block which has the number of operation cycles greater than that already stored in the register updates the number of operation cycles stored in the register to its number of operation cycles.

13. An emulator for emulating an operation of a processor for implementing an instruction in a pipeline, comprising:
a processor object corresponding to the processor;
a plurality of stages of processing blocks, in which adjacent processing blocks are associated with each other to correspond to the pipeline, the plurality of stages of processing blocks being operational in parallel and in an independent manner in accordance with control of the processor object; and
cycle number storing means for storing, for each step of the input instruction, the number of operation cycles of the processing block which has the greatest number of operation cycles among said plurality of stage of processing blocks,
wherein the processor object outputs the number of operation cycles stored in the cycle number storing means as the number of execution step cycles of the pipeline in the step.

14. The emulator according to claim 13, wherein the processor object sets the number of operation cycles stored in the cycle number storing means in the first step of the instruction to an initial value, and determines, for each operation of the processing block in each stage, whether or not the number of operation cycles of the operated processing block is greater than the number of operation cycles already stored in the cycle number storing means, and allows the number of operation cycles stored in the cycle number storing means to be updated when the number of operation cycles of the operated processing block is larger.

15. The emulator according to claim 13, wherein the plurality of stages of processing blocks include a processing block having a fixed number of operation cycles regardless of the instruction.

16. The computer-attachable device for emulating a function of a processor for implementing an instruction in a pipeline in an apparatus different from the one loaded with the processor, wherein:
the computer-attachable device provides, in the apparatus through cooperation with hardware resources of the apparatus, upon being attached to the apparatus:
a processor object corresponding to the processor;
a plurality of stages of processing blocks, in which adjacent processing blocks are associated with each other to correspond to the pipeline, the processing blocks being operational in parallel and in an independent manner in accordance with control of the processor object; and
cycle number storing means for storing, for each step of the input instruction, the number of operation cycles of the processing block which has the greatest number of operation cycles among the plurality of stages of processing blocks;
the computer-attachable device causes the processor object to output the number of operation cycles stored in the cycle number storing means as the number of execution step cycles of the pipeline for this step.

17. An emulator program for causing a computer to operate as an emulator for emulating an operation of a processor for implementing an instruction in a pipeline, the emulator program causing the computer to operate as:
a processor object corresponding to the processor;
a plurality of stages of processing blocks, in which adjacent processing blocks are associated with each other to correspond to the pipeline, the processing blocks being operational in parallel and in an independent manner in accordance with control of the processor object; and
cycle number storing means for storing, for each step of the input instruction, the number of operation cycles of the processing block among said plurality of stages of processing blocks,
wherein the emulator program causes the processor object to output the number of operation cycles stored in the cycle number storing means as the number of execution step cycles of the pipeline in the step.
